(19) United States
(12) Patent Application Publication
(10) Pub. No.: US 2006/0293941 A1
(43) Pub. Date: Dec. 28, 2006

(54) Systems and methods for modeling business processes using graphical symbols

(76) Inventors: Konstantin Ivanov, Saarbruecken (DE); Uwe Roediger, Saarbruecken (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/447,908

(22) Filed: Jun. 7, 2006

Related U.S. Application Data
(60) Provisional application No. 60/687,847, filed on Jun. 7, 2005.

(51) Int. Cl. G05B 19/418; G06F 3/00

(52) U.S. Cl. 705/8; 715/764

(57) ABSTRACT

Systems and methods are provided for modeling business processes. In one implementation, a computer-implemented method is provided for graphically modeling a business process. In the method, the business process may be modeled with a plurality of symbols. Each symbol may have a color corresponding to a semantic grouping and may comprise an icon pictorially representing a BPEL concept. Further, each symbol may be linked to XML code, wherein the XML code is adapted to implement the BPEL concept represented by the symbol.

### CROSS REFERENCE TO RELATED APPLICATIONS(S)

This application claims the benefit of priority from U.S. Provisional Application No. 60/687,847, entitled “Computerized Systems and Methods for Modeling and Executing Business Processes,” filed Jun. 7, 2005, the disclosure of which is expressly incorporated herein by reference to its entirety.

### BACKGROUND

I. Technical Field

The present invention generally relates to the field of business software and to computerized systems and methods for modeling business processes. More particularly, the invention relates to computerized systems and methods for graphically modeling business processes using symbols that represent, for example, Business Process Execution Language (BPEL) concepts.

II. Background Information

Successful companies are driven by efficient business processes. A “business process” describes functions or activities that occur in a particular order and that create added value for a company. For example, a business process for order management may define the functions associated with processing an incoming order from receipt of the order to shipping and invoicing the order. Since business processes are crucial to performance, companies often spend a significant amount of time and effort to design efficient business processes. Further, in order to efficiently design business processes, many companies use modeling tools. A “modeling tool” may include software and/or computerized systems that can be used to plan business a process. In general, modeling tools may depict, analyze, and optimize business processes.

Some modeling tools allow users to model a business process in a graphical form using symbols to represent a logical sequence of steps in a process. One example of a type of graphical modeling is event-driven process chain (EPC) modeling. EPC modeling has been developed within the framework of the ARIS Platform provided by IDS Scheer AG (Saarbruecken Germany). The ARIS Platform provides a tool portfolio for designing, implementing, and controlling business processes. An EPC model is an ordered graphical representation of events and functions. Further, an EPC model provides connectors that allow alternative and parallel execution of processes. For example, EPC models may include logical operators, such as OR, AND, and XOR that describe relationships between elements of the process. An “element” may refer to one step or activity, for example. Additionally, in an EPC model, logical relationships between elements are termed a “control flow.” However, an EPC model, while graphical, does not actually implement a business process. It is merely a schematic representation of a business process

In order to implement business processes in a standardized fashion using computer programming, companies including BEA, IBM, Microsoft, SAP and Siebel developed a standard called Business Process Execution Language for Web Services (BPEL4WS) and, more generally, Business Process Execution Language (BPEL). As used herein, the term “BPEL” is used to refer to both BPEL4WS and BPEL. For more information, see for example a copy of the BPEL standard (Version 1.1), which is available at:

http://www-128.ibm.com/developerworks/librarv/specification/ws-bpel/.

In general, BPEL is a language that standardizes business processes in a distributed environment. By having a standardized language, separate companies can interconnect applications and share data. BPEL defines business processes that can interact with external entities through, for example, Web service operations defined using WSDL (Web Services Description Language) Version 1.1, and that manifest themselves as Web services defined using WSDL 1.1. WSDL is an XML format for describing network services as a set of endpoints operating on messages containing either document-oriented or procedure-oriented information. The operations and messages are described abstractly and bound to a concrete network protocol and message format that define an endpoint. Related concrete endpoints are combined into abstract endpoints (services).

For example, when using BPEL, a programmer can implement a process by defining it at a high-level. A process that has been defined at a high-level is referred to as an “abstract process.” Further, a BPEL abstract process represents a set of publicly observable behaviors in a standardized fashion. For example, an abstract process includes information such as when to send data for a purchase order, when to ship a product, when to transmit an order confirmation, when to send an invoice, etc. By contrast, traditional programming languages typically implement a single transaction and involve writing code that accesses local logic and resources, such as files and databases, for example.

Since BPEL is a formal XML-based process description notation, users that lack technical experience cannot efficiently create BPEL processes. Further, a large number of defined BPEL concepts are required to be understood and known to programmers in order to model a complete business process. Since the library of defined BPEL concepts is large, it is difficult for a user modeling a business process to easily identify the concepts that he or she wishes to implement. In addition, users must be familiar with XML and computer programming in order to implement BPEL processes. Therefore, conventional modeling techniques are limited and suffer from one or more drawbacks.

In view of the foregoing, there is a need for improved systems and methods for graphically modeling business processes. For example, there is a need for systems and methods that use graphical symbols to represent BPEL concepts. There is also a need for systems and methods that organize or categorize the graphical symbols with their related functionality in a logical fashion so that users may quickly identify the functionality provided by symbols. Therefore, systems and methods are needed that implement BPEL concepts in a manner that is easily understood by users and that allow users to implement BPEL concepts at a high-level without learning complex programming techniques.

### SUMMARY

Consistent with embodiments of the present invention, computer-implemented systems and methods are provided for graphically modeling a business process. In such systems and methods, the business processes may be modeled with symbols. Each symbol may have a color corresponding to a semantic grouping and may comprise an icon pictorially representing a BPEL concept. Further, each symbol may be linked to XML code. The XML code may implement the BPEL concept represented by each symbol.

Consistent with another embodiment of the present invention, a system is provided for graphically modeling a business process. The system may comprise a graphical user interface module. The graphical user interface module may be adapted to enable a user to model the business process with symbols. Each symbol may have a color corresponding to a semantic grouping and may comprise an icon pictorially representing a BPEL concept. The system may also include a module for linking each symbol to XML code. The XML code may implement the BPEL concept represented by each symbol.

Consistent with yet another embodiment of the present invention, a computer-readable medium comprising programmable instructions is adapted to perform a method for graphically modeling a business process. The method may comprise modeling the business process with a plurality of symbols. Each symbol may have a color corresponding to a semantic grouping and may comprise an icon pictorially representing a BPEL concept. Further, each symbol may be linked to XML code. The XML code may implement the BPEL concept represented by each symbol.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 illustrates an exemplary system for graphically modeling BPEL concepts, consistent with an embodiment of the present invention;

FIG. 2 is an exemplary software architecture for providing a business process modeling tool, consistent with an embodiment of the present invention;

FIG. 3 is a flow diagram of an exemplary method for graphically modeling business processes, consistent with an embodiment of the present invention;

FIGS. 4A-4G illustrate exemplary symbols that correspond to BPEL concepts, consistent with embodiments of the present invention;

FIG. 5 illustrates an exemplary graphical user interface for modeling business processes, consistent with an embodiment of the present invention; and

FIG. 6 illustrates an exemplary graphical user interface that includes a business process and activity details of a symbol included in the process, consistent with an embodiment of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Consistent with embodiments of the present invention, systems and methods are providing for modeling and graphically representing BPEL concepts. As further disclosed herein, embodiments of the present invention provide a set of symbols that model executable processes in a graphical form according to the BPEL standard, e.g., BPEL (Version 1.1).

In embodiments of the present invention, a “symbol” may depict a unique BPEL concept in a graphical form. A symbol may include a text description that names or describes a function performed by an object that is modeled by the symbol. An “object” refers to a BPEL concept that has been expressed in an executable form and that may implement the BPEL concept as part of a business process. The text description may be modified or deleted by a user. A symbol may further comprise a graphical element formed of, for example, a large rectangle with rounded corners and a small quadratic icon on the left upper corner. Each icon may correspond to a semantic of a BPEL concept implemented by a particular symbol. Further, symbols may be implemented according to color groups, where each color group reflects a semantic closeness of the symbols in the same color group. Both parts of a symbol (the large rectangle and the icon) may have the same color. One of ordinary skill in the art will recognize that the physical location, shape, and size of the icon may be varied in keeping with the spirit and scope of the present invention.

Consistent with embodiments of the present invention, a modeling tool implemented by the present invention may provide a user with a workspace to arrange and connect symbols. Symbols may be connected with each other based on relationship rules between symbols of the same type or of different types. For example, certain relationship rules may dictate whether certain symbols can be connected to each other. Further, these rules may be implemented consistent with the BPEL standard. When an improper connection of a symbol to another symbol is attempted by a user, and error message may be displayed as a warning of the error to the user and/or the connection may be disallowed.

Consistent with one embodiment, symbols may be made available for user selection from a symbol library. The symbol library may be located in a portion of a work space included in a graphical user interface. For example, the symbol library may include symbols that have been arranged based on color groups. Users may model a business process using symbols from the symbol library. Once a user has modeled a business process, the process may be saved for later modification and/or changes may be made to reflect changes in the business process. Further, once a user has completed a model of a business process, an executable program corresponding to the modeled BPEL process may be migrated to a server in order to provide a web service that implements the modeled business process for a company.

For purposes of illustration, embodiments of the invention are described herein with reference to implementations within an ARIS environment. Further, exemplary embodiments are presented with reference to ARIS BPEL symbols. As will be appreciated by one skilled in the art, however, embodiments of the invention are not limited to the ARIS environment and may be applied in other environments, including computerized or software-based modeling and graphical tools. As used herein, the term “software” encompasses any and all types of software, including computer software, computer program products, and program modules and components, including business and financial software applications and components.

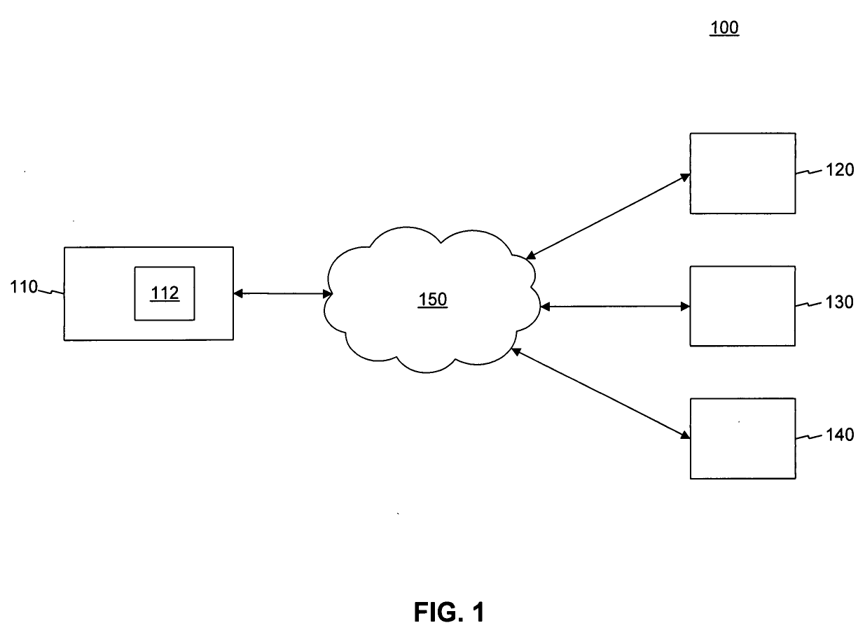

FIG. 1 illustrates an exemplary system 100 for graphically modeling BPEL concepts, consistent with an embodiment of the present invention. As shown in system 100, server 110 and terminals 120,130, and 140 are connected to a network 150. One of skill in the art will appreciate that although one server and three terminals are depicted in FIG. 1, any number of servers and terminals may be provided. Furthermore, one of ordinary skill in the art will recognize that functions provided by one or more components of system 100 may be combined.

Network 150 provides communications between the various entities in system 100, such as server 110 and terminals 120-140. In addition, server 110 or terminals 120-140 may access legacy systems (not shown) via network 150, or may directly access legacy systems and/or databases. Network 150 may be a shared, public, or private network and encompasses a wide area or local area. Further, network 150 may be implemented through any suitable combination of wired and/or wireless communication networks and may comprise a local area network (LAN), a wide area network (WAN), an intranet, or the Internet.

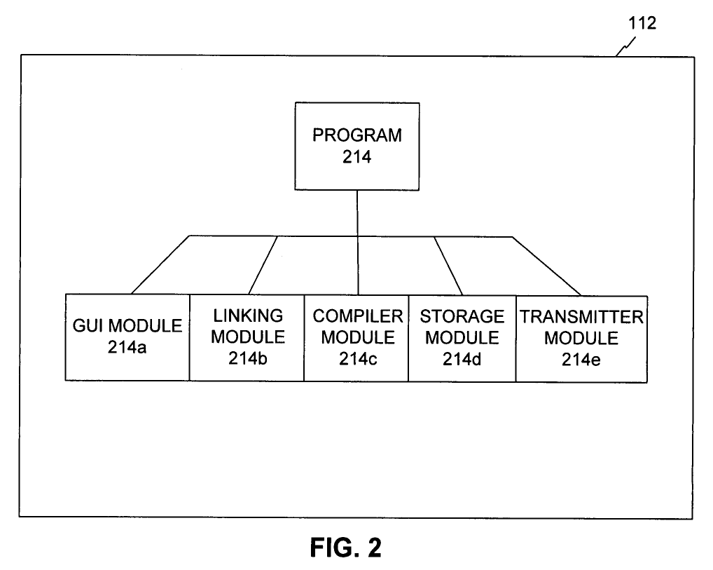

Server 110 may comprise a general purpose computer (e.g., a personal computer, network computer, server, or mainframe computer) having a processor (not shown) that may be selectively activated or reconfigured by a computer program to perform one or more methods consistent with the present invention. Server 110 may also be implemented in a distributed network. Alternatively, server 110 may be specially constructed for carrying-out methods consistent with the present invention. Furthermore, server 110 may include a data storage 112 for storing program modules that implement a graphical modeling tool for modeling business processes using BPEL concepts. Program modules for implementing a graphical modeling tool are discussed in further detail with respect to FIG. 2.

Terminals 120-140 may be any type of device for communicating with server 110 over network 150. For example, terminals 120-140 may be personal computers, handheld devices, or any other appropriate computing platform or device capable of exchanging data with network 150. Terminals 120-140 may each include a processor (not shown) and data storage (not shown) for storing data, such as modeled business processes that implement BPEL concepts.

For example, terminals 120-140 may execute program modules that provide one or more graphical user interfaces (GUIs) for interacting with network resources via, for example, a web browser. The web browser may access network resources through a web portal. Further, users may access data stored in server 110 via network 150 through a web browser or software application running on, for example, any one of terminals 120-140. The web portal may include options for allowing a user to log onto a secure site provided by server 110 by supplying credentials, such as a usemame and a password. Once logged onto the site, the web portal may display a series of screens prompting the user to make various selections for modeling business processes using a modeling tool. Since embodiments of the present invention may be implemented using an HTTPS (hypertext transfer protocol secure) environment, data transfer over a network, such as the Internet, may be done in a secure fashion.

Consistent with an aspect of the present invention, a web interface generated by application server 110 that is displayed to users of terminals 120-140 may provide various options. For example, a user may select, using the web interface, a business process modeling tool. In other embodiments, users of terminals 120-140 may select a business process modeling tool from a GUI generated by software executing on one of terminals 120-140.

Consistent with embodiments of the present invention, the modeling tool may provide a user with a work space in which the user may model a business process using symbols. The symbols may be selected from a symbol library that may be provided by the modeling tool. Further, the user may modify or add text descriptions to symbols, as well as connect symbols together in order to model a business process. Since symbols having related functionality are grouped together based on color groups, the user may more readily identify the symbols needed to model a particular business process. Further, since the symbols include an icon, the user may quickly identify the function implemented by a BPEL concept associated with a particular symbol.

FIG. 2 shows an exemplary software architecture for providing a business process modeling tool, consistent with an embodiment of the present invention. The software architecture may be stored in data storage 112, as shown in FIG. 1, for example. Alternatively, the software architecture may be stored in whole or in part in a data storage of any or each of terminals 120-140. In one embodiment, data storage 112 stores instructions of program 214, which when executed, perform the functions of a business process modeling tool that implements BPEL concepts.

To implement the business process modeling tool, program 214 may include instructions in the form of one or more software modules 214a-214e. Software modules 214a-214e may be written using any known programming language, such as C++, XML, etc. As shown in FIG. 2, program 214 includes GUI module 214a, linking module 214b, compiler module 214c, storage module 214d, and transmitter module 214e.

GUI module 214a may provide processing to display data and receive data selections from users of the modeling tool. For example, GUI module 214a may generate a user interface for a modeling tool. The user interface may include a work space for implementing graphical representations of business processes. Further, the user interface may include selectable options in the form of buttons, drop-down lists, etc. GUI module 214a may also display libraries of symbols that correspond to BPEL processes. For example, a user may select a particular type of symbol from a selectable list or from a graphical representation of different groupings of symbols. The groupings may be organized by color groups, for example. A user may expand each group in order to review the symbols that have been classified as being part of a particular group. Groups may be defined for basic activities, structured activities, data definitions, interaction concepts, etc. Further, each grouping may be assigned a color. For example, the basic activities symbols may be green and the structured activities symbols may be blue. Exemplary embodiments of symbol groupings, colors, and icons are discussed below in further detail.

Linking module 214b may link each symbol to XML code implementing a BPEL concept. For example, each symbol may correspond to a particular function or activity provided by the BPEL standard. The BPEL concept represented by a symbol may include XML code that represents programming instructions for implementing the BPEL concept.

Compiler module 214c may compile a business process expressed in symbols. For example, once a user has completed the design of a business process that is expressed in symbols, the user may wish to compile an executable program that can be distributed to a server, such as, for example, server 110. Once running on a server, the business process may be executed as a web service that implements the business process for a company. Further, compiler module 214c may also include functionality for checking for errors in a modeled business process. Certain rules may be implemented by compiler module 214c once symbols have been connected in order to evaluate whether the symbols are properly connected according to the BPEL standard. For example, a start symbol cannot be followed by another start symbol. A user may also initiate error checking at any point in the modeling process.

Storage module 214d may save data representing a business process for persistent storage. For example, during the process of designing a business process, a user may save the symbolic representation of the business process. In particular, storage module 214d may save the business process to a local storage, such as one of terminals 120-140, or to a network storage.

Transmitter module 214e may distribute an executable program for a modeled business process to a server specified by a user in order to provide a web service. For example, once an executable program has been compiled, a user may designate a server available over a network. The executable program may then be transmitted to the server in order to provide a web service for a company.

While the example provided in FIG. 2 shows program modules 214a-214e as being resident in data storage 112 of server 110, one of ordinary skill in the art will appreciate that program modules 214a-214e may be stored in any medium or location, including data storages of any one of terminals 120,130, or 140, as mentioned above.

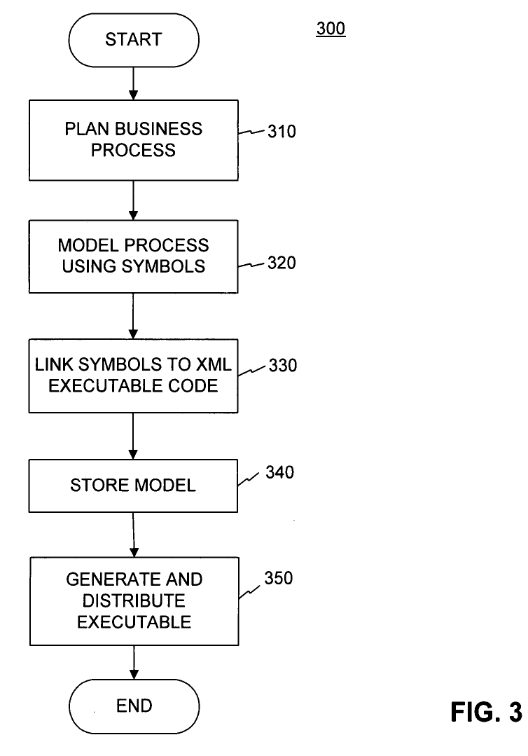

Referring now to FIG. 3, a flow diagram 300 is provided of an exemplary method for modeling a business process that implements BPEL concepts using a data processing system, consistent with an embodiment of the present invention. The method may allow a user to model a business process with a modeling tool that implements BPEL concepts. The business process may be expressed using symbols, and each symbol may correspond to underlying XML code that implements a corresponding BPEL concept. Further, because the process is based on a high-level graphical representation of BPEL concepts that are expressed graphically as symbols, a user need not have an in-depth knowledge of programming languages or computer science. For example, a user may identify symbols based on a color of the symbol and/or an icon included with the symbol.

At the start of the process, a user may plan a business process (Step 310). For example, a user may plan a business process using a tool, such as one provided via the ARIS Platform by IDS Scheer AG. The process may be planned using an EPC model or any appropriate tool. Alternatively, a user may not use a tool and may instead plan a business process by determining and recording requirements of the process. Such a process can be planned out on paper or by using a word processor, for example. The process then proceeds to step 320.

In step 320, the user models the business process using a modeling tool that implements BPEL concepts using symbols. For example, the user may use a graphical user interface (GUI) that provides a work space to select symbols to model the process. The selection of the symbols is facilitated by the color scheme and icons that are displayed as part of the symbols. For example, the color scheme may provide a semantic organization of the symbols and each icon may provide a pictorial description of the functionality of a particular symbol. Each graphical symbol may be linked to XML code implementing the represented BPEL concept. Further, symbols may be selected from a symbol library. The symbol library may include categories of symbols that are organized based on similar or related functionality. For example, a symbol designating the start of a business process and a symbol designating the end of a business process may be included in the same category and may share the same color.

Next, each symbol included in the modeled BPEL process may be linked to XML executable code. (Step 330). For example, each symbol may relate to underlying executable code that implements an activity or function of a business process. The modeling tool may include functionality that automatically generates XML executable code for each symbol. The XML code is generated based on the particular symbol. For example, a particular symbol, as identified by its icon, implements a particular BPEL process. Accordingly, the XML code that is linked to a particular symbol implements the BPEL process for that particular symbol. For some symbols, the XML executable code linked to the symbol may comprise at least a start tag, content, and an end. For other symbols, the XML executed code linked to the symbol may comprise more than one set of start tags, elements, and end tags.

Next, in step 340, the user may save the modeled business process. In this step, the business process may be stored, for example, to local or network storage. The process may then proceed to step 350.

After a user has saved the modeled business process, a user may compile and generate an executable program and distribute that program to a server, such as server 110, whereby the process may provide a web service to a company. (Step 350). For example, in the example of a purchase order, the executable business process may be migrated to server 110 and provide a web service for receiving and processing business orders for a company. One of ordinary skill in the art will recognize that step 350 may be optional, as the process may conclude after the business process has been modeled.

Furthermore, in one embodiment, the user may execute an error checking function that determines whether the modeled process has errors at any step of the process. Errors may occur by placing symbols in an improper order, for example. When an error is discovered, a user may replace an incorrect symbol with one that results in a proper syntax. In addition, errors messages may be displayed to a user after a user incorrectly attempts to link two symbols together. Symbol errors may be implemented by rules consistent with the BPEL standard.

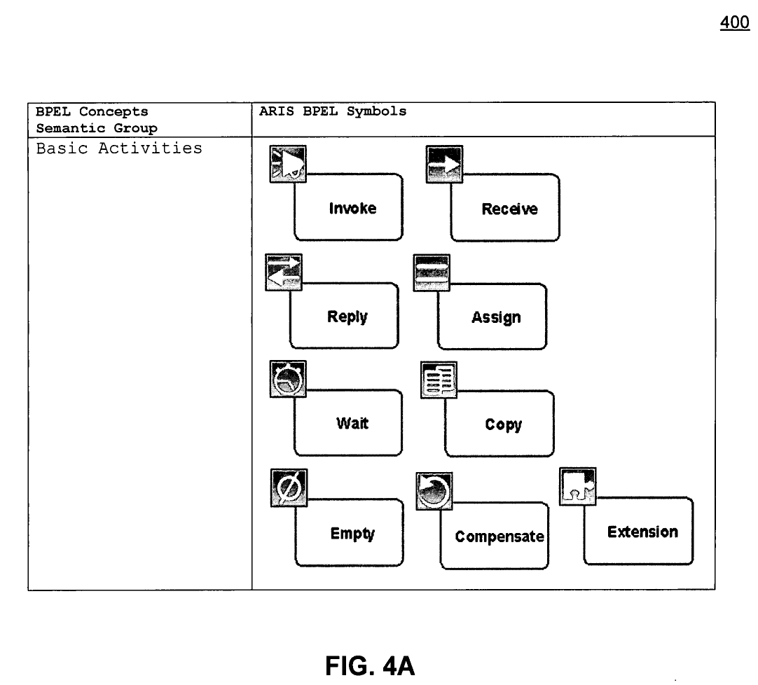

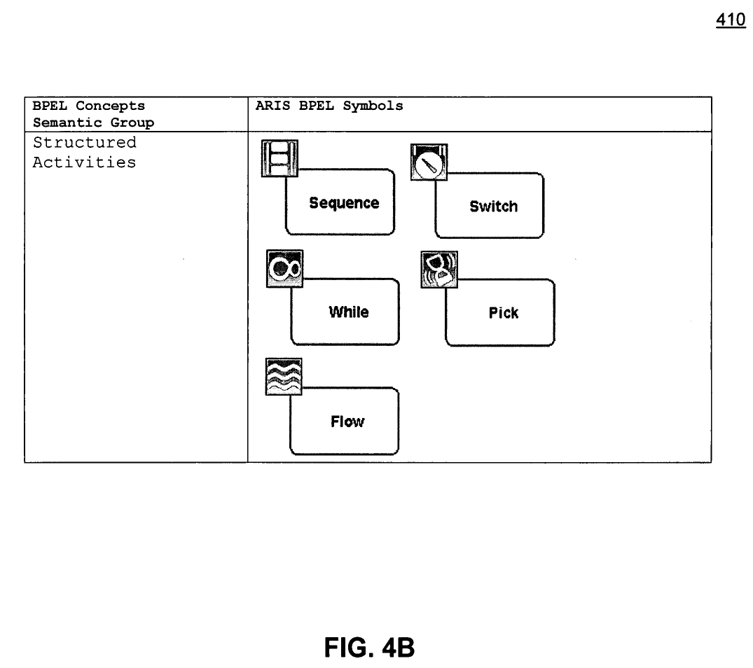

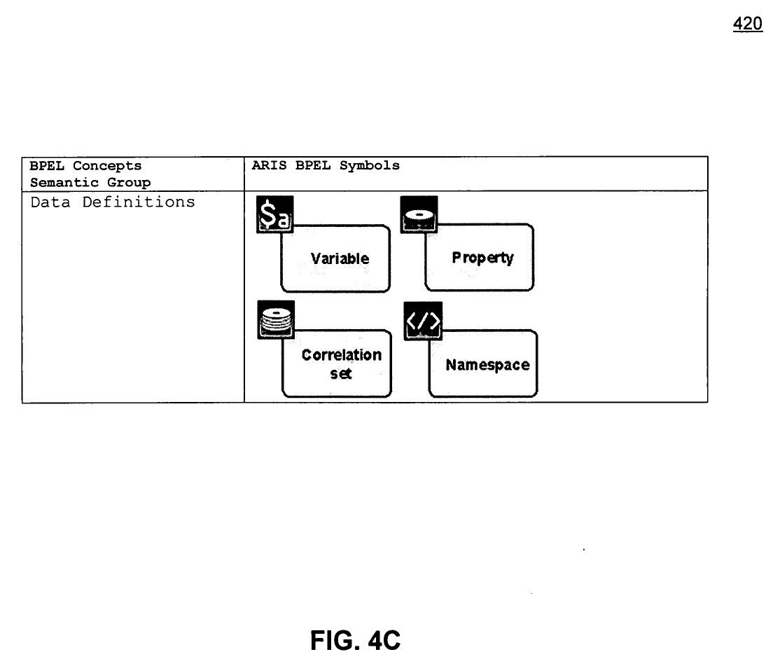

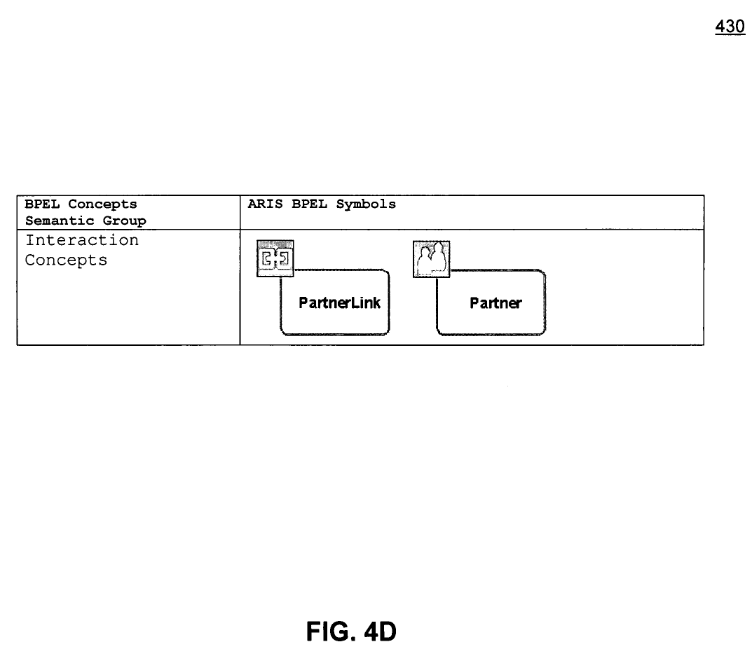

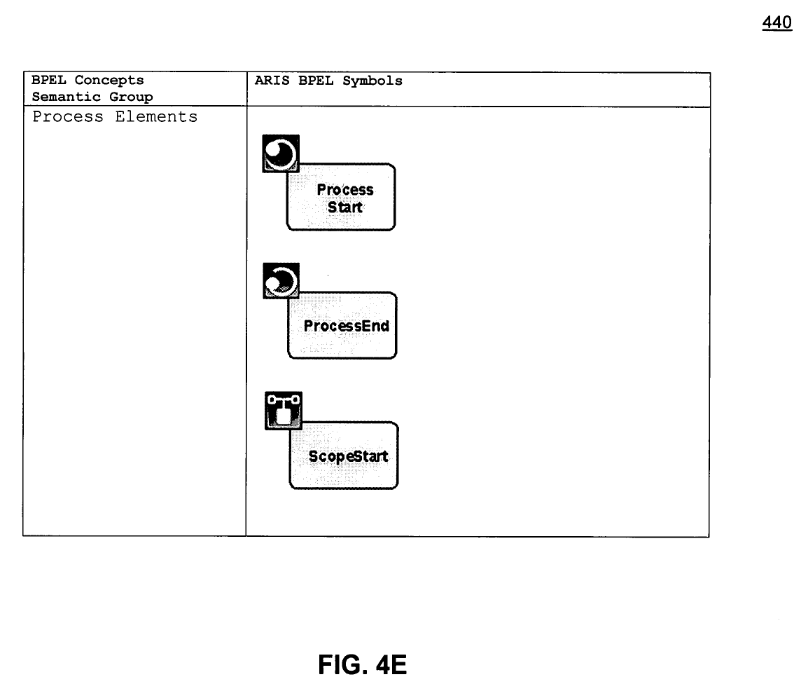

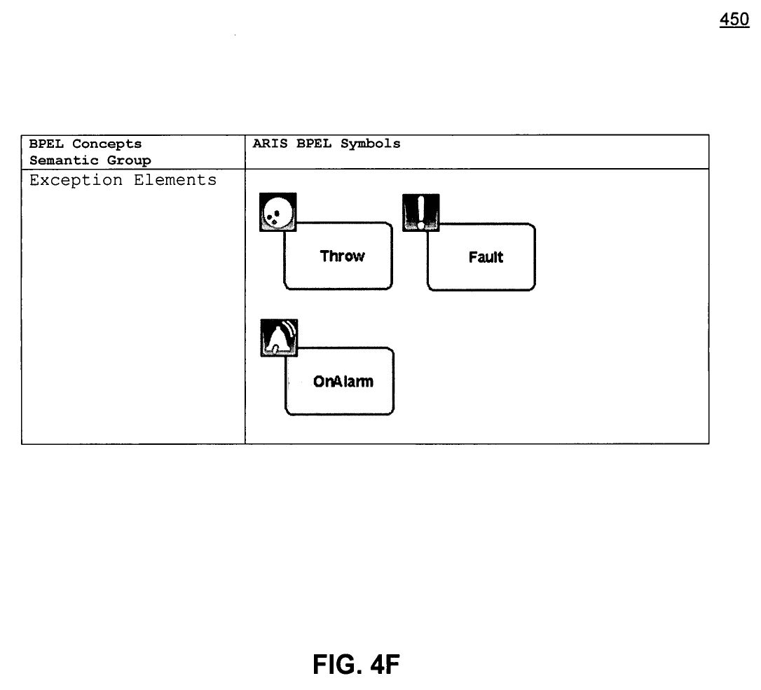

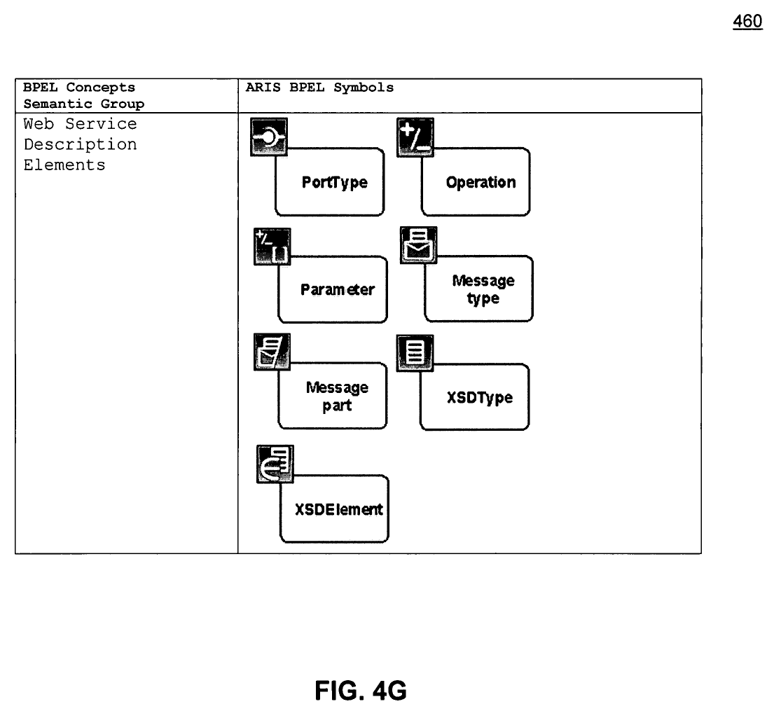

FIGS. 4A-4G illustrate exemplary symbols for implementing a business process using BPEL concepts, consistent with embodiments of the present invention. Each grouping of symbols refers to a semantic group. Accordingly, each symbol in a group may have the same color. For example, the groupings shown in FIGS. 4A-4G may be based on semantic categories. Each category may be represented by a unique color for ease of identification by users. Each symbol may also include a text description. For any of the symbols, a user may change the textual description by adding, modifying, or deleting the text. Consistent with other embodiments of the present invention, the location of the icons may be altered, the icons may be depicted in a different fashion and/or substituted by numbers, pictures, text, or omitted entirely from the symbols.

FIG. 4A shows a grouping of symbols that represent a basic BPEL activities group 400. All of the symbols in basic activities group 400 may have the same color, such as green. Web services can be used to perform work in a BPEL business process. Accordingly, “invoking” an operation on such a service is a basic activity. As shown in FIG. 4A, a symbol representing a basic activity “Invoke” may include an icon that resembles a megaphone.

A “Receive” symbol may specify a partner link that the symbol expects to receive from and the port type and operation that it expects the partner to invoke. It may also specify a variable that receives message data. A symbol representing basic activity “Receive” may include an icon that depicts an incoming action. Basic activity “Reply” may include an icon that depicts an action in reply to incoming action, thereby reflecting closeness to the “Receive” symbol. For example, a “Reply” symbol may send a response to a request previously accepted through a receive activity.

An “Assign” symbol may update a variable value. A symbol representing basic activity “Assign” may include an icon that is an abstract depiction of an assignment. A “Copy” symbol may be used along with the “Assign” symbol and may represent copying data from one variable to another. The “Copy” symbol may include an icon that depicts the function of copying, such as an icon of two overlaying documents.

Further, in group 400, a “Wait” symbol may allow a business process to specify a delay for a time period or until a deadline is reached. A symbol representing basic activity “Wait” may include an icon that resembles a clock or a watch. An “Empty” symbol may indicate an activity does nothing, such as when a fault should be caught or suppressed. A symbol representing basic activity “Empty” may include an icon of an abstract depiction of an empty set. A symbol representing basic activity “Compensate” may include an icon that depicts a counter-clockwise movement along a line, reflecting a closeness to “ProcessStart” and “ProcessEnd” symbols, which are discussed below. A “Compensate” symbol may invoke a compensation handler. An “Extension” symbol may represent an execution platform specific extension of the BPEL4WS standard within a BPEL Process flow. The “Extension” symbol may include an icon that resembles a puzzle part.

FIG. 4B shows a grouping of symbols that represent a structured activities group 410. All of the symbols in structured activities group 410 may have the same color, such as blue. A user may specify activities that are performed in sequence using a “Sequence” symbol. The sequence is completed once the final activity in the sequence has completed. The “Sequence” symbol may include an icon that resembles consequent frames of a film. A symbol representing a structured activity “Switch” may include an icon that depicts a switch having different positions.

Further, in group 410, a symbol representing a structured activity “While” may include an icon that resembles a loop. The “While” symbol may indicate that a certain activity is to be repeatedly performed. A symbol representing a structured activity “Pick” may include an icon that resembles a sand-glass notifying on an event. The “Pick Symbol” may await an occurrence of a set of events. Once the events occur, an activity that is associated with the event that occurred may be performed. A symbol representing a structured activity “Flow” may include an icon that resembles parallel waves of a stream. The “Flow” symbol may create a set of concurrent activities that are directly nested within it.

FIG. 4C shows a grouping of symbols that represent a data definitions group 420. All of the symbols in data definitions group 420 may have the same color, such as purple. A symbol representing a data definition “Variable” may include an icon that is an abstract depiction of a declaration of a variable in a programming language. The “Variable” symbol may represent data that constitutes a state of a business process. A symbol representing a data definition “Property” may include an icon that resembles a disk containing arbitrary data. The “Property” symbol may represent a correlation between entities. For example, a buyer may have a correlated exchange with a seller by sending a purchase order. The purchase order number may constitute a correlation token. Later, when the seller sends an invoice with the purchase order, the seller may indicate that payment messages should include the invoice number because the invoice and purchase order have been correlated together.

In addition, in group 420, a symbol representing a data definition “Correlation Set” is a set of “Property” elements and may include an icon that depicts a set of disks, thereby reflecting closeness to the “Property” symbol. A “Namespace” symbol may represent an XML Namespace. The “Namespace” symbol may include an icon that depicts a definition limited by XML tag brackets.

FIG. 4D shows a grouping of symbols that represent an interaction concepts group 430. All of the symbols in interaction concepts group 430 may have the same color, such as yellow. A “PartnerLink” symbol may include an icon that depicts two connected entities. The “PartnerLink” symbol may represent a link to other partner services with which the business process interacts. A “Partner” symbol may include an icon that resembles two figures near by each other. The “Partner' symbol may represent capabilities that are required of a business partner.

FIG. 4E shows a grouping of symbols that represent a process elements group 440. All of the symbols in process elements group 440 may have the same color, such as red. A “Process Start” symbol may represent a start node of a BPEL process. The icon included in the “Process Start” symbol may resemble an initial position of a movement along a line. A “Process End” symbol may represent an end node of a BPEL process. The icon included in a “Process End” symbol may resemble an final position of a movement along a line. A “ScopeStart” symbol may represent a behavioral context for an activity and may provide fault handlers, event handlers, a compensation handler, data variables, and a correlation set. Further, a “ScopeStart” symbol may include an icon that depicts a scope semantic as box within a process, following its other parts.

FIG. 4F shows a grouping of symbols that represent an exception elements group 450. All of the symbols in exception elements group 450 may have the same color, such as orange. A symbol representing activity “Throw” may include an icon that resembles a bowl that can be thrown. The “Throw” symbol may be used by a business process when the process needs to signal an internal fault explicitly. A “Fault” symbol may include an icon that depicts an exclamation mark and may represent an error. An “OnAlarm” symbol may represent a definition of an event handler part within a BPEL process. The “OnAlarm” symbol may include an icon that resembles a ringing bell.

FIG. 4G shows a grouping of symbols that represent a web service elements group 460. All of the symbols in the web services elements group 460 may have the same color, such as gray. A “Port Type” symbol may represent a WSDL (Web Services Description Language) port type and may include an icon that resembles an interface as a connection point of between two entities. An “Operation” symbol of a WSDL operation may include an icon of an abstract depiction of basic math operations, such as addition and subtraction. A “Parameter” symbol of a WSDL parameter may include an icon that is a combination of the “Operation” symbol icon and two brackets that are typically used in programming languages. A “Message Type” symbol of a WSDL message may include an icon that resembles an envelope with a text document, thereby reflecting closeness to an “XSDType” symbol, which is discussed below. A “MessagePart” symbol may represent a WSDL message and may include an icon that includes a part of the “MessageType” symbol icon, thereby reflecting closeness to that symbol. An “XSDType” symbol may include an icon that resembles a text document. An “XSDElement” symbol may include an icon that is a combination of the icon included in the “XSDType” symbol and the letter “E.”

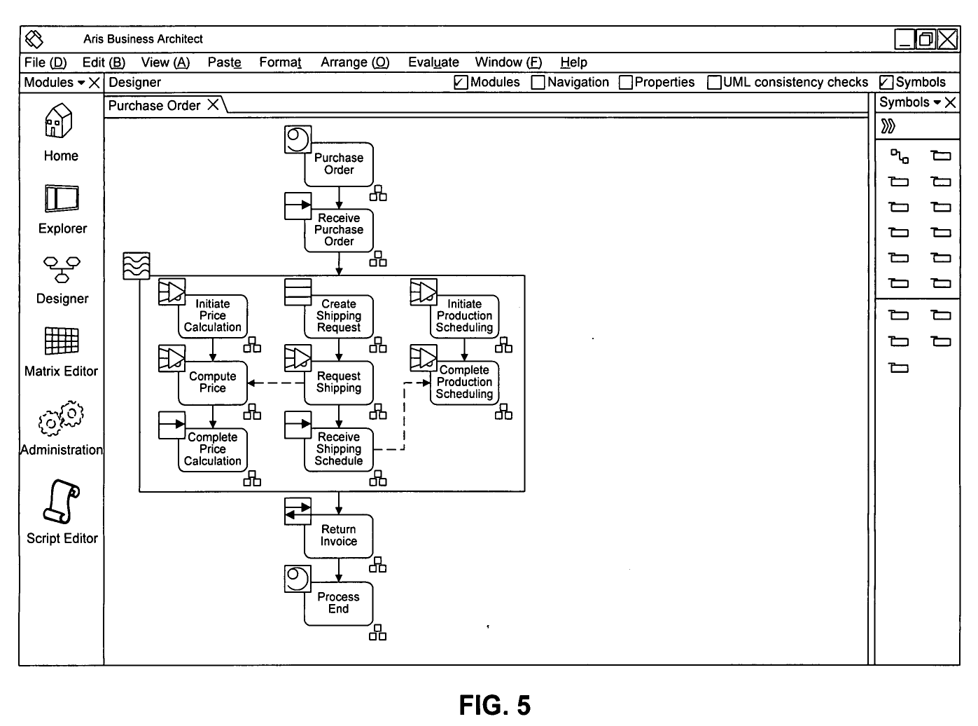

FIG. 5 illustrates an exemplary graphical user interface for modeling business processes, consistent with an embodiment of the present invention. As discussed above, systems and methods consistent with the present invention may be implemented using a GUI. In one embodiment, a user may place symbols in a work space, such as the one shown in FIG. 5.

As illustrated in FIG. 5, an exemplary business process is for processing a purchase order. Further, as shown in FIG. 5, a library of different symbols is available, such as the symbol section on the right hand side of the screen. The symbols may be organized according to color. For example, clicking on a symbol of a particular color may display all grouped symbols having that color in the symbol library. Further, as shown in the exemplary business process, each symbol includes an icon. Additional user options are available on the left side of the screen.

At the start of the exemplary business process, the “Process Start” symbol has been labeled “Purchase Order” by the user. The “Process Start” symbol flows to a “Receive” symbol, which represents an incoming action, i.e., the purchase order. Next, a larger box of symbols having a semantic relationship are designated by the “Flow” symbol. In particular, there are three processes executing in parallel within the “Flow” symbol. The processes are for: (1) calculating a price, (2) creating a shipping request, and (3) initiating production scheduling. Next, the output of the parallel processes flow to a “Reply” symbol, which has been labeled “Return Invoice” to indicate that the invoice is sent. Finally, the process flows to a “Process End” symbol.

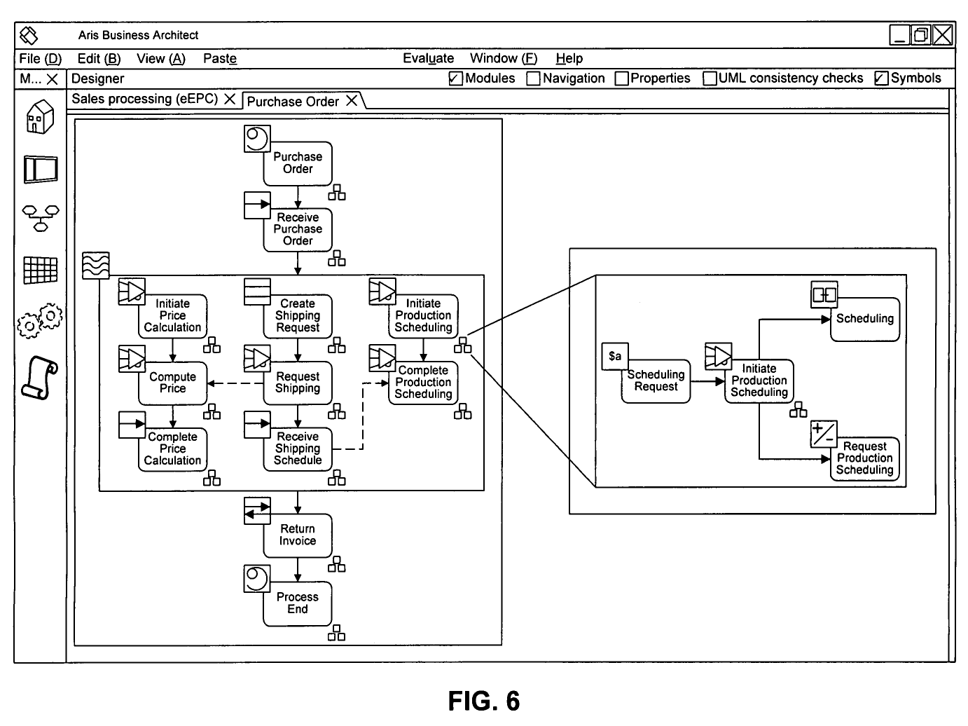

FIG. 6 illustrates an exemplary BPEL process that shows activity details of a specific symbol, consistent with an embodiment of the present invention. The example in FIG. 6 shows the exemplary purchase order business process that was discussed above in relation to FIG. 5. As shown in FIG. 6, the “Initiate Production Scheduling” symbol has been expanded to show “activity details.” “Activity details” may specify further processes that are included within a particular symbol. For example, the details of the “Initiate Production Scheduling” symbol may be expanded when a user, for example, double clicks on the small expansion icon located to the lower right of the symbol. The user may similarly double click on the expansion icon to remove the activity details from the screen.

Accordingly, consistent with the present invention, systems and methods provide a business process modeling tool. The modeling tool may be implemented as a GUI providing the user with various options. Embodiments of the tool provide functionality for a user to quickly identify and use symbols that correspond to BPEL concepts. As disclosed, symbols may comprise graphical elements formed of, for example, a large rectangle with rounded corners and a small quadratic icon on the left upper corner. The semantic of each symbol may correspond to a semantic of represented concepts. Symbols may be implemented according to color groups, where each color group reflects a semantic closeness of the symbols in the color group. Each symbol may be linked to underlying XML code that implements a BPEL concept corresponding to the symbol. Further, a user may compile an executable program from a modeled business process and distribute the executable program to a server in order to provide a web service.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A computer-implemented method for graphically modeling a business process, the method comprising:
modeling the business process with a plurality of symbols, each symbol having a color corresponding to a semantic grouping and comprising an icon pictorially representing a BPEL concept; and
linking each graphical symbol to XML code, wherein the XML code implements the BPEL concept represented by the symbol.

2. The computer-implemented method of claim 1, further comprising:
connecting a first symbol to a second symbol to model a flow of the business process.

3. The computer implemented method of claim 1, further comprising:
storing a model of the business process in a server accessible via a network.

4. The computer-implemented method of claim 1, further comprising:
storing a model of the business process in a local storage.

5. The computer-implemented method of claim 1, further comprising:
compiling a model of the business process into an executable program, wherein the executable program implements a web service; and
transmitting the executable program over a network to a server.

6. The computer-implemented method of claim 1, wherein at least one of the symbols further includes a rectangle with rounded corners and wherein the icon is a smaller rectangle that is located at the left upper corner of the rectangle.

7. The computer-implemented method of claim 1, wherein at least one of the symbols is displayed in a work space of a graphical user interface, and the graphical user interface includes a symbol library, the symbol library having the plurality of symbols grouped into categories.

8. The computer-implemented method of claim 7, further comprising:
expanding at least one of symbols by clicking an expansion icon located beside the selected symbol, wherein the expanded symbol includes one or more additional symbols.

9. A system for graphically modeling a business process, the system comprising:
a graphical user interface module, the graphical user interface module adapted to enable a user to model the business process with a plurality of symbols, each symbol having a color corresponding to a semantic grouping and comprising an icon pictorially representing a BPEL concept; and
a module for linking each symbol to XML code, wherein the XML code implements the BPEL concept represented by the symbol.

10. The system of claim 9, further comprising:
a module for storing a model of the business process in a server accessible via a network.

11. The system of claim 9, further comprising:
a module for storing a model of the business process in a local storage.

12. The system of claim 9, further comprising:
a module for compiling a model of the business process into an executable program, wherein the executable program implements a web service; and
a module for transmitting the executable program over a network to a server.

13. The system of claim 9, wherein at least one of the symbols is a rectangle with rounded corners and the icon is a smaller rectangle that is located at the left upper corner of the rectangle.

14. The system of claim 9, wherein at least one of the symbols is displayed in a work space of a graphical user interface generated by the graphical user interface module.

15. A computer-readable medium comprising programmable instructions adapted to perform a method for graphically modeling a business process, the method comprising:
modeling the business process with a plurality of symbols, each symbol having a color corresponding to a semantic grouping and comprising an icon pictorially representing a BPEL concept; and
linking each symbol to XML code, wherein the XML code implements the BPEL concept represented by the symbol.

16. The computer-readable medium of claim 15, further comprising:
connecting a first symbol to a second symbol to model a flow of the business process.

17. The computer-readable medium of claim 15, further comprising:
storing a model of the business process in a server accessible via a network.

18. The computer-readable medium of claim 15, further comprising:
storing a model of the business process in a local storage.

19. The computer-readable medium of claim 15, further comprising:
compiling a model of the business process into an executable program, wherein the executable program implements a web service; and
transmitting the executable program over a network to a server.

20. The computer-readable medium of claim 15, wherein at least one of the symbols is a rectangle with rounded corners and the icon is a smaller rectangle that is located at the left upper corner of the rectangle.

21. The computer-readable medium of claim 15, wherein at least one of the symbols is displayed in a work space of a graphical user interface, and the graphical user interface includes a symbol library, the symbol library having the plurality of symbols grouped into categories.

22. The computer-readable medium of claim 21, further comprising:
expanding at least one of the symbols by clicking an expansion icon located beside the selected symbol, wherein the expanded symbol includes one or more additional symbols.
